(19) United States
(12) Patent Application Publication
(10) Pub. No.: US 2015/0108388 A1
(43) Pub. Date: Apr. 23, 2015

(54) Light Absorbing Composition And Light-Absorbing Structure Made Therefrom

(71) Applicant: Taiflex Scientific Co., Ltd., Kaohsiung (TW)

(72) Inventors: Yu-Chih Kao, Kaohsiung (TW); Chen-Kuo Lu, Kaohsiung (TW); Tzu-Ching Hung, Kaohsiung (TW)

(73) Assignee: Taiflex Scientific Co., Ltd., Kaohsiung (TW)

(21) Appl. No.: 14/058,371

(22) Filed: Oct. 21, 2013

(51) Int. Cl. G02B 1/04; G02B 5/20

(52) U.S. Cl. CPC G02B 1/04; G02B 5/208
USPC 252/62

(57) ABSTRACT

Provided is a light-absorbing composition, which is prepared by melt-extruding a mixture containing light-absorbing particle agglomerates and a polymer. The light-absorbing particle agglomerates comprises a dispersant and light-absorbing particles capped with the dispersant, and the light-absorbing particle agglomerates dispersed in the light-absorbing composition and have an average particle size ranging from 10 nanometers to 800 nanometers. Accordingly, the light-absorbing composition can effectively absorb near-infrared light and store infrared heat, and thereby providing infrared-absorbing, heat-insulating and heat-storing abilities. Furthermore, a light-absorbing structure made from the light-absorbing composition has good transparency, higher infrared absorbance, light-absorbing and heat-releasing efficiencies, and is thereby beneficial to keep the temperature equilibrium of buildings or vehicles.

### BACKGROUND OF THE INVENTION

1. Field of the Invention

The invention relates to a light-absorbing composition, more especially to a light-absorbing composition which can effectively absorb near-infrared light and store heat. Another aspect of the present invention relates to a light-absorbing structure, which is made from the light-absorbing composition.

2. Description of the Prior Art

For energy conservation, a light-absorbing material applicable for windows of buildings and/or vehicles has been a prioritized subject for research and development in various fields.

Common heat-insulating material in the prior art usually fails to have both good heat insulation and good transparency. A heat-insulating material that has a good transparency normally has an inferior heat insulation; in contrast, the heat-insulating material that has a good heat insulation normally has an inferior transparency.

However, the heat-insulating material applied to either buildings or vehicles is required to provide sufficient visibility, heat insulation, and heat storage, so as to ensure a good sight and safe driving, and also to keep the indoors or car-interior in a temperature equilibrium. Therefore, excessive energy consumptions caused by lighting or constant temperature maintenance can be avoided.

### SUMMARY OF THE INVENTION

Given that the conventional heat-insulating material fails to satisfy the requirements of visibility, heat insulation and heat storage at the same time, the main objective of the present invention is to provide a light-absorbing composition, which can effectively absorb near-infrared light and store heat. Furthermore, a light-absorbing structure made from the light-absorbing composition can have improved transmittance, thereby enhancing its heat-insulation index.

To achieve the aforementioned objective, the present invention provides a light-absorbing composition, which is prepared by melt-extruding a mixture containing light-absorbing particles agglomerates and a polymer.

Preferably, the light-absorbing particle agglomerates are dispersed in the polymer to form the light-absorbing composition, and the light-absorbing particle agglomerates have an average particle size ranging from 10 nanometers to 800 nanometers. Said light-absorbing particle agglomerates comprise: a dispersant; and light-absorbing particles capped with the dispersant, wherein the light-absorbing particles have an average particle size ranging from 5 to 100 nanometers, and an amount of the light-absorbing particles ranges from 0.05 wt % to 20 wt % based on a total amount of the light-absorbing composition.

Preferably, the step of melt-extruding the mixture containing the light-absorbing particle agglomerates and the polymer comprises: dispersing the light-absorbing particles and the dispersant in a solvent, so as to form the light-absorbing particle agglomerates; mixing the light-absorbing particle agglomerates and the polymer to form the mixture; and melt-extruding the mixture to obtain the light-absorbing composition. Said solvent may be a polar solvent such as water, ethanol, and isopropanol; or a non-polar solvent such as aliphatic alkane and aromatic alkane. By means of the foregoing dispersion step, the light-absorbing particle agglomerates are well-dispersed in the mixture, and the light-absorbing particle agglomerates in the light-absorbing composition have an average particle size ranging from 10 nanometers to 800 nanometers.

Preferably, the light-absorbing composition is prepared by melt-extruding the mixture containing the light-absorbing particle agglomerate and the polymer at a temperature ranging from 240° C. to 270° C.

Preferably, an amount of the light-absorbing particles ranges from 0.05 percentage by weight (wt %) to 20 wt %, an amount of the dispersant ranges from 0.05 wt % to 20 wt %, and an amount of the polymer ranges from 60 wt % to 99.9 wt % based on a total amount of the light-absorbing composition.

Preferably, the light-absorbing particles are made from a material selected from the group consisting of antimony tin oxide (also called antimony-doped tin oxide), indium tin oxide (also called tin-doped indium oxide), cesium tungsten oxide (also called cesium-doped tungsten oxide) and their combinations.

Preferably, the average particle size of the light-absorbing particle agglomerate ranges from 10 nanometers to 200 nanometers.

In accordance with one embodiment, the dispersant has a molecular weight ranging from 1000 Dalton (Da) to 20000 Da and includes a functional group selected from the group consisting of hydroxyl group, epoxy group, carboxylic acid group and amino group. Preferably, the dispersant includes two or more kinds of functional groups simultaneously.

Preferably, the dispersant comprises polyol, polyether polyol, polyester polyol, polyester-polysiloxane, polyamide wax, oxidized polyolefin wax, polyester wax or their combinations. More specifically, the dispersant comprises polyethylene glycol, polycaprolactone diol, polycarbonate diol, polycaprolactone-polysiloxane, oxidized polyethylene wax, polyethylene-vinyl acetate wax, or any combination thereof.

In accordance with another embodiment, the dispersant has a chemical structure of R⁴R³R²SiO(R¹)₃, and R¹ is —CH₃, —C₂H₅ or —Cl; R² is an alkyl group having 2 to 18 carbon atoms; and R³ and R⁴ are each independently selected from the group consisting of epoxy group, amino group and alkenyl group. More specifically, the dispersant may be 3-aminopropyltriethoxysilane (APTES) or 3-epoxypropoxypropyltrimethoxysilane (EPPTMS).

Preferably, the light-absorbing composition comprises a lubricant, and the light-absorbing composition is prepared by melt-extruding a mixture containing the light-absorbing particle agglomerates, the polymer and the lubricant. An amount of the dispersant ranges from 0.1 wt % to 10 wt % based on the total amount of the light-absorbing composition. The lubricant may be stearic acid, stearate, polyethylene wax, oxidized polyethylene wax, polyethylene-vinyl acetate wax or any combination thereof. More specifically, the stearate may be, but is not limited to, potassium stearate or sodium stearate.

Preferably, the polymer is selected from the group consisting of polyethylene terephthalate (PET), polybutylene terephthalate (PBT), polycarbonate (PC) and any combination thereof.

The present invention also provides a light-absorbing structure, which is made from the aforementioned light-absorbing composition. Wherein, the light-absorbing structure is a light-absorbing panel, a light-absorbing film or a light-absorbing fiber.

Preferably, the light-absorbing particle agglomerates are dispersed in the polymer to form the light-absorbing composition, and have an average particle size ranging from 10 nanometers to 200 nanometers.

Preferably, the light-absorbing structure has a thickness of 0.5 micrometers to 1000 micrometers.

Preferably, the light-absorbing structure has a visible light transmittance (VLT) and a infrared absorbance, and a product of a sum of the visible light transmittance and the infrared absorbance multiplied by 100 is larger than or equal to 100; and more preferably, the product is larger than or equal to 124. Herein, the product of a sum of the visible light transmittance and the infrared absorbance multiplied by 100 is generally to evaluate a heat-insulation index of the light-absorbing structure, and the higher heat-insulation index indicates that the light-absorbing structure has a better performance in visibility, heat insulation and heat storage.

Based on the aforesaid, by controlling the particle size of the light-absorbing particle agglomerates within an appropriate range, the light-absorbing composition obtained by melt-extrusion can effectively absorb the near-infrared light to provide light-absorbing, heat-insulating and heat-storing abilities. Moreover, the light-absorbing structure made from the light-absorbing composition acquires excellent light-absorbing and heat-releasing efficiencies, and also obtains improved transmittance, infrared absorbance, and heat-insulation index. Accordingly, the light-absorbing structure in accordance with the present invention satisfies the requirements of visibility, heat insulation and heat-storage simultaneously, and is beneficial to keep the temperature equilibrium in buildings or vehicles.

Other objectives, advantages and novel features of the invention will become more apparent from the following detailed description when taken in conjunction with the accompanying drawing and tables.

### BRIEF DESCRIPTION OF THE DRAWING

FIG. 1 is a full transmittance spectrum of light-absorbing panels of Examples 1 and 3.

### DETAILED DESCRIPTION OF THE PREFERRED EMBODIMENTS

The present invention was further illustrated by the following examples; it should be understood that the examples and embodiments described herein are for illustrative purposes only and should not be construed as limiting the embodiments set forth herein.

### Example 1

### Preparation of a Light Absorbing Composition

Firstly, antimony tin oxides having particle sizes of 10 nm to 20 nm (purchased from Ishihara Sangyo Kaisha, Japan) as light-absorbing particles, and APTES as a dispersant were mixed in 95 vol % of ethanol, and then agitated to obtain an antimony tin oxide suspension. Herein, the molar ratio of antimony relative to tin in the antimony tin oxides was 1:9, and a weight ratio of the antimony tin oxides:APTES:ethanol of the antimony tin oxide suspension was 30:2:68.

After that, the antimony tin oxide suspension was ball-milled with 1-mm zirconium beads at 1000 rpm for 6 hours to obtain a slurry containing dispersed antimony tin oxides.

Subsequently, the slurry containing dispersed antimony tin oxides was spray-dried at 100° C. to obtain dried antimony tin oxide granular composites. Herein, the dried antimony tin oxide granular composites, i.e., said light-absorbing particle agglomerates, contained antimony tin oxides particles capped with APTES.

Finally, the dried antimony tin oxide particle agglomerates and pure PET resin were mixed and injected into a twin screw extruder, and then melt-extruded at 240° C. to 270° C. to obtain a light-absorbing composition. The light-absorbing composition contained 10 wt % of antimony tin oxides.

The obtained light-absorbing composition contained antimony tin oxides particles capped with APTES and pure PET resin. The amounts of the aforementioned components, relative to a total amount of the light-absorbing composition being 100 wt %, were rounded off to first decimal place and listed in Table 1.

### Example 2

### Preparation of a Light Absorbing Composition

The light-absorbing composition in the instant Example was prepared similarly as described in Example 1. The difference between Examples 1 and 2 was that a stearic acid was used as a lubricant to prepare the light-absorbing composition. Detailed preparation of the instant Example was described as follows.

Firstly, antimony tin oxides, APTES and stearic acid were mixed in 95 vol % of ethanol, and agitated to obtain an antimony tin oxide suspension. Herein, a weight ratio of the antimony tin oxides:APTES:stearic acid:ethanol of the antimony tin oxide suspension was 30:1:1:68.

After that, the antimony tin oxide suspension was ball-milled with 1-mm zirconium beads at 1000 rpm for 6 hours to obtain a slurry containing dispersed antimony tin oxides.

Subsequently, the slurry containing dispersed antimony tin oxides was spray-dried at 100° C. to obtain dried antimony tin oxide granular composites. Herein, the dried antimony tin oxide granular composites were directed to light-absorbing particle agglomerates that contained antimony tin oxides capped with APTES and stearic acid.

Finally, the dried antimony tin oxide particle agglomerates and pure PET resin were mixed together and injected into a twin screw extruder, and then melt-extruded at 240° C. to 270° C., so as to obtain a light-absorbing composition. The light-absorbing composition contained 10 wt % of antimony tin oxides.

The obtained light-absorbing composition contained antimony tin oxides, APTES, stearic acid and pure PET resin. The amounts of the aforementioned components, relative to a total amount of the light-absorbing composition being 100 wt %, were rounded off to first decimal place. The components and respective calculated results were also listed in Table 1.

### Example 3

### Preparation of a Light Absorbing Composition

The light-absorbing composition of the instant example was prepared similarly as described in Example 1, except that the dispersant used in the instant Example was Solsperse 2000 (purchased from Lubrizol Corporation, USA).

The components used in the instant Example and their respective amounts relative to a total amount of the light-absorbing composition being 100 wt % were also listed in Table 1.

### Example 4

### Preparation of a Light Absorbing Composition

The light-absorbing composition of the instant example was prepared similarly as described in Example 1, except that the dispersant used in the instant Example was Disperbyk 2000 (purchased from BYK Corporation, Germany), and a weight ratio of the antimony tin oxides:Disperbyk 2000:ethanol of the antimony tin oxide suspension was 30:0.6:69.4.

The components used in the instant Example and their respective amounts relative to a total amount of the light-absorbing composition being 100 wt % were also listed in Table 1.

### Example 5

### Preparation of a Light Absorbing Composition

The light-absorbing composition of the instant example was prepared similarly as described in Example 1, except that the dispersant used in the instant Example was 20 kDa of polyol, and a weight ratio of the antimony tin oxides:polyol:ethanol of the antimony tin oxide suspension was 30:5:65.

The components used in the instant Example and their respective amounts relative to a total amount of the light-absorbing composition being 100 wt % were also listed in Table 1.

### Example 6

### Preparation of a Light Absorbing Composition

The light-absorbing composition of the instant example was prepared similarly as described in Example 1, except that the dispersant used in the instant Example was 3-(methylacryloyloxy)propyltrimethoxysilane, and a weight ratio of the antimony tin oxides:

3-(methylacryloyloxy)propyltrimethoxysilane:ethanol of the antimony tin oxide suspension was 30:5:65.

The components used in the instant Example and their respective amounts relative to a total amount of the light-absorbing composition being 100 wt % were also listed in Table 1.

### Comparative Example 1

### Preparation of a Light Absorbing Composition

The antimony tin oxides having particle sizes of 10 nm to 20 nm used in the instant comparative example were not dispersed and dried. The antimony tin oxides and pure PET resin were mixed together with a weight ratio of 1:9, and both were injected into a twin screw extruder, and then melt-extruded at 240° C. to 270° C. to obtain a light-absorbing composition.

Herein, no dispersant was contained in the light-absorbing composition, and the components used in the instant Comparative example and their respective amounts relative to a total amount of the light-absorbing composition being 100 wt % were also listed in Table 1.

### Comparative Example 2

### Preparation of a Light Absorbing Composition

As similar with the Comparative example 1, the antimony tin oxides used in the instant comparative example for preparing the light absorbing composition were not dispersed and dried.

The difference between Comparative Examples 1 and 2 was that the antimony tin oxides without dispersion and drying were directly mixed with APTES and pure PET resin, and all of them were injected into a twin screw extruder, and then melt-extruded at 240° C. to 270° C. to obtain a light-absorbing composition.

Wherein, the weight ratio of the antimony tin oxides without dispersion and drying: APTES:pure PET resin was 1:0.1:8.9.

The obtained light-absorbing composition contained the antimony tin oxides, APTES and pure PET resin. The amounts of the aforementioned components, relative to a total amount of the light-absorbing composition being 100 wt %, were rounded off to first decimal place. The components and respective calculated results were listed in Table 1.

### Comparative Example 3

### Preparation of a Light Absorbing Composition

The light-absorbing composition was prepared similarly as described in Example 1, except that the APTES and ethanol were respectively replaced by Solsperse 21000 (purchased from Lubrizol Corporation, USA) and methylethyl ketone to prepare an antimony tin oxide suspension. Detailed preparation of the instant Comparative example was described as follows.

Firstly, antimony tin oxides and Solsperse 21000 were mixed in methyl ethyl ketone, and agitated to obtain an antimony tin oxide suspension. Herein, a weight ratio of the antimony tin oxides:Solsperse 21000:methylethyl ketone of the antimony tin oxide suspension was 30:0.6:69.4.

After that, the antimony tin oxide suspension was ball-milled with 1-mm zirconium beads at 1000 rpm for 6 hours to obtain a slurry containing dispersed antimony tin oxides.

Subsequently, the slurry containing dispersed antimony tin oxides was spray-dried at 100° C. to obtain dried antimony tin oxide granular composites. Herein, the dried antimony tin oxide granular composites contained antimony tin oxides and Solsperse 21000.

Finally, the dried antimony tin oxide granular composites and pure PET resin were mixed together and injected into a twin screw extruder, and then melt-extruded at 240° C. to 270° C. to obtain a light-absorbing composition containing 10 wt % of antimony tin oxides.

The obtained light-absorbing composition contained antimony tin oxides, Solsperse 21000 and pure PET resin. The amounts of the aforementioned components, relative to a total amount of the light-absorbing composition being 100 wt %, were rounded off to first decimal place and also listed in Table 1.

### Comparative Example 4

### Preparation of a Light Absorbing Composition

The light-absorbing composition was prepared similarly as described in Comparative example 3, except that Solsperse 21000 was replaced by Solsperse 3000.

The obtained light-absorbing composition of Comparative example 4 contained antimony tin oxides, Solsperse 3000, and pure PET resin. The amounts of the aforementioned components, relative to a total amount of the light-absorbing composition being 100 wt %, were rounded off to first decimal places. The components and respective calculated results were also listed in Table 1.

### Comparative Example 5

### Preparation of a Light Absorbing Composition

The light-absorbing composition was prepared similarly as described in Comparative example 1. The differences between the Comparative examples 1 and 5 were that antimony tin oxides without dispersion and drying, H-Si6440P (purchased from Evonik Industries, Germany), and pure PET resin were directly mixed and injected into a twin screw extruder, and then melt-extruded at 240° C. to 270° C. to obtain the light-absorbing composition. Herein, the weight ratio of antimony tin oxides:H-Si6440P:pure PET resin was 1:0.2:8.8.

The obtained light-absorbing composition of Comparative example 5 contained antimony tin oxides, H-Si6440P, and pure PET resin. The amounts of the aforementioned components, relative to a total amount of the light-absorbing composition being 100 wt %, were rounded off to first decimal places. The components and respective calculated results were also listed in Table 1.

TABLE 1
the amounts of light-absorbing particles, dispersant, polymer and lubricant
and average particle size of the light-absorbing particle agglomerates of
the light-absorbing compositions in Examples and Comparative Examples

| | component/amount | | | | | |
|---|---|---|---|---|---|---|
| | | | | | average particle size | |
| | light-absorbing | | | | of light-absorbing | |
| | particles | dispersant | polymer | lubricant | particle agglomerate | |
| Example 1 | ATO/ | APTES/ | PET/ | — | 103 | nm |
| | 10 wt % | 0.6 wt % | 89.4 wt % | | | |
| Example 2 | ATO/ | EPPTMS/ | PET/ | Stearic | 100 | nm |
| | 10 wt % | 0.3 wt % | 89.4 wt % | acid/ | | |
| | | | | 0.3 wt % | | |
| Example 3 | ATO/ | Solsperse | PET/ | — | 270 | nm |
| | 10 wt % | 20000/ | 89.4 wt % | | | |
| | | 0.6 wt % | | | | |
| Example 4 | ATO/ | Disperbyk | PET/ | — | 160 | nm |
| | 10 wt % | 2000/ | 89.8 wt % | | | |
| | | 0.2 wt % | | | | |
| Example 5 | ATO/ | polyol/ | PET/ | — | 97 | nm |
| | 10 wt % | 1.6 wt % | 88.4 wt % | | | |
| Example 6 | ATO/ | APTES/ | PET/ | — | 120 | nm |
| | 10 wt % | 1.6 wt % | 88.4 wt % | | | |
| Comparative | ATO | — | PET/ | — | 10 | μm |
| example 1 | 10 wt % | | 90 wt % | | | |
| Comparative | ATO/ | APTES/ | PET/ | — | 6.4 | μm |
| example 2 | 10 wt % | 1.0 wt % | 89.0 wt % | | | |
| Comparative | ATO/ | Solsperse | PET/ | — | 810 | nm |
| example 3 | 10 wt % | 21000/ | 89.8 wt % | | | |
| | | 0.2 wt % | | | | |
| Comparative | ATO/ | Solsperse | PET/ | — | 920 | nm |
| example 4 | 10 wt % | 3000/ | 89.8 wt % | | | |
| | | 0.2 wt % | | | | |
| Comparative | ATO/ | H-Si6440P/ | PET/ | — | 4.5 | μm |
| example 5 | 10 wt % | 2.0 wt % | 88 wt % | | | |

### Experimental Example 1

### Average Particle Size of the Light-Absorbing Granular Composite of the Light-Absorbing Composition

In the instant experimental example, the light-absorbing compositions obtained in Examples and Comparative examples were respectively dissolved in the mixture of phenol and tetrachloroethane, and then the particle size analyzer was employed to measure the average particle sizes of the light-absorbing particles agglomerates dispersed in the light-absorbing composition after melt-extrusion. The results were listed in Table 1.

As shown in Table 1, by means of dispersing, drying and melt-extruding steps, all obtained light-absorbing compositions of Examples 1 to 6 had particle sizes less than 800 nanometers. In comparison with Comparative examples 1, 2 and 5, the light-absorbing compositions prepared without dispersion and drying steps failed to have average particle sizes minimized to nano-scale. In comparison with Comparative examples 3 and 4, if the used dispersants were not suitable for dispersion, the light-absorbing compositions, prepared by a method including dispersion and drying steps, still failed to have average particle sizes less than 800 nanometers.

### Experimental Example 2

### Light-Absorbing and Heat-Releasing Efficiencies of the Light-Absorbing Structure Made from Light-Absorbing Composition

In the instant experimental example, the light-absorbing compositions of Examples and Comparative examples were used as raw material, and followed by a similar process as described below to prepare the light-absorbing panels for measurement of the light-absorbing and heat-releasing properties thereof.

The light-absorbing composition and PET resin with a weight ratio of 1:19 were mix-extruded by a thin-plate extruder to obtain 0.4 mm-thick light-absorbing panel.

Subsequently, the light-absorbing panel was installed at a position with a distance of 100 centimeters and an angle of 45 degrees from a 500-W halogen lamp, and then irradiated with the halogen lamp for 10 minutes.

A 4 mm-thick pure PET panel was provided as control sample in the instant experimental example. The pure PET panel was also installed at a position with a distance of 100 centimeters and an angle of 45 degrees from a 500-W halogen lamp, and then irradiated with the halogen lamp for 10 minutes.

Finally, surface temperature of the light-absorbing panels of Examples 1 to 6 and Comparative examples 1 to 5 and pure PET panel were respectively measured using a thermography. The differences between the respective surface temperatures of the light-absorbing panels and the pure PET panel thereof indicated the light-absorbing and heat-storage efficiencies of the light-absorbing panels. The results are listed in Table 2.

The heat-insulation index of each light-absorbing panel was obtained by a sum of the visible light transmittance and the infrared absorbance multiplied by 100, wherein the infrared absorbance of the light-absorbing panel was calculated by subtracting infrared transmittance from 1.

TABLE 2
the differences between the respective surface temperatures
of the light-absorbing panels of Examples 1 to 6 and Comparative
examples 1 to 5 and the pure PET panel thereof, and visible
light transmittances, infrared absorbances and heat-insulation
indices of the light-absorbing structures

| | difference of | | | |
|---|---|---|---|---|
| | surface | visible light | infrared | heat-insulation |
| | temperature | transmittance | absorbance | index |
| Example 1 | +2.9° C. | 80% | 43% | 123 |
| Example 2 | +2.9° C. | 81% | 42% | 123 |
| Example 3 | +2.2° C. | 73% | 28% | 101 |
| Example 4 | +2.6° C. | 78% | 31% | 109 |
| Example 5 | +2.9° C. | 81% | 43% | 124 |
| Example 6 | +2.7° C. | 78% | 41% | 119 |
| Comparative | +1.4° C. | 40% | 43% | 83 |
| example 1 | | | | |
| Comparative | +1.5° C. | 42% | 43% | 85 |
| example 2 | | | | |
| Comparative | +2.1° C. | 52% | 47% | 99 |
| example 3 | | | | |
| Comparative | +2.1° C. | 50% | 48% | 98 |
| example 4 | | | | |
| Comparative | +1.5° C. | 42% | 43% | 85 |
| example 5 | | | | |

As shown in Table 2, the differences of surface temperatures between the light-absorbing panels of Examples 1 to 6 and the control sample were larger than those between Comparative examples 1 to 5 and the control sample. It has proved that the light-absorbing compositions of Examples 1 to 6 can provide better light-absorbing and heat-releasing efficiencies to the light-absorbing panels.

### Experimental Example 3

### Visible Light Transmittance and Heat-Insulation Index of the Light-Absorbing Structure Made from Light-Absorbing Composition

In the instant experimental example, the light-absorbing panels of Examples 1 to 6 and Comparative examples 1 to 5 were irradiated with light of wavelength ranging from 300 nanometers to 2500 nanometers, so as to measure their visible light transmittances at 550 nanometers, infrared absorbances and heat-insulation indices. Wherein, said infrared absorbance was calculated by 1 minus the near-Infrared transmittance at 950 nanometers, and the heat-insulation index was obtained by a sum of the visible light transmittance and the infrared absorbance multiplied by 100. Calculated results were also listed in Table 2.

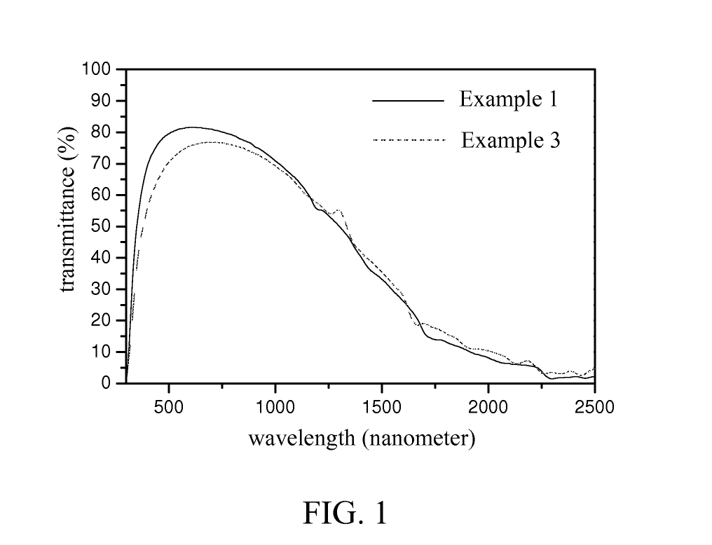

With reference to FIG. 1, the light-absorbing panels of Examples 1 and 3 had a visible light transmittance more than 70%, even 80%, and had a lower near-Infrared transmittance at 950 nanometers in the near-Infrared region. Results demonstrated that the light-absorbing compositions are beneficial to improve both visible light transmittances and infrared absorbances of the light-absorbing panels.

According to the experimental results from visible light transmittance and heat-insulation index, it proved that the light-absorbing panels made from the light-absorbing compositions of Examples 1 to 6 have improved visible light transmittances and also excellent heat-insulation indices. Accordingly, the light-absorbing panels in the aforementioned Examples have improved transparencies and shield near-Infrared better than those in Comparative examples.

Even though numerous characteristics and advantages of the present invention have been set forth in the foregoing description, together with details of the structure and features of the invention, the disclosure is illustrative only. Changes may be made in the details and arrangement of parts within the principles of the invention to the full extent indicated by the broad general meaning of the terms in which the appended claims are expressed.

What is claimed is:

1. A light-absorbing composition, which is prepared by melt-extruding a mixture containing light-absorbing particle agglomerates and a polymer.

2. The light-absorbing composition as claimed in claim 1, wherein the light-absorbing particle agglomerates are dispersed in the polymer to form the light-absorbing composition, and the light-absorbing particle agglomerates have an average particle size ranging from 10 nanometers to 800 nanometers and comprise:
a dispersant, and
light-absorbing particles capped with the dispersant and have an average particle size ranging from 5 to 100 nanometers, wherein an amount of the light-absorbing particles ranges from 0.05 wt % to 20 wt % based on a total amount of the light-absorbing composition.

3. The light-absorbing composition as claimed in claim 2, wherein the average particle size of the light-absorbing particle agglomerates ranges from 10 nanometers to 200 nanometers.

4. The light-absorbing composition as claimed in claim 2, wherein a material of the light-absorbing particles is selected from the group consisting of antimony tin oxide, indium tin oxide, cesium tungsten oxide and any combination thereof.

5. The light-absorbing composition as claimed in claim 3, wherein a material of the light-absorbing particles is selected from the group consisting of antimony tin oxide, indium tin oxide, cesium tungsten oxide and any combination thereof.

6. The light-absorbing composition as claimed in claim 2, wherein an amount of the dispersant ranges from 0.05 wt % to 20 wt % based on a total amount of the light-absorbing composition.

7. The light-absorbing composition as claimed in claim 2, wherein the dispersant has a molecular weight ranging from 1000 Da to 20000 Da and includes a functional group selected from the group consisting of hydroxyl group, epoxy group, carboxylic acid group and amino group.

8. The light-absorbing composition as claimed in claim 2, wherein the dispersant is selected from the group consisting of polyol, polyether polyol, polyester polyol, polyester-polysiloxane, polyamide wax, oxidized polyolefin wax, polyester wax and any combination thereof.

9. The light-absorbing composition as claimed in claim 2, wherein the dispersant comprises polyethylene glycol, polycaprolactone diol, polycarbonate diol, polycaprolactone-polysiloxane, oxidized polyethylene wax, polyethylene-vinyl acetate wax, or any combination thereof.

10. The light-absorbing composition as claimed in claim 2, wherein the dispersant has a chemical structure of R⁴R³R²SiO(R¹)₃, and
R¹ is —CH₃, —C₂H₅ or —Cl;
R² is an alkyl group having 2 to 18 carbon atoms; and
R³ and R⁴ are each independently selected from the group consisting of epoxy group, amino group and alkenyl group.

11. The light-absorbing composition as claimed in claim 1, wherein the light-absorbing composition comprises a lubricant, an amount of the lubricant ranges from 0.1 wt % to 10 wt % based on a total amount of the light-absorbing composition, and the light-absorbing composition is prepared by melt-extruding the mixture containing the light-absorbing particle agglomerates, the polymer and the lubricant; and the lubricant comprises stearic acid, stearate, polyethylene wax, oxidized polyethylene wax, polyethylene-vinyl acetate wax or any combination thereof.

12. The light-absorbing composition as claimed in claim 1, wherein the polymer is selected from the group consisting of polyethylene terephthalate, polybutylene terephthalate, polycarbonate and any combination thereof.

13. A light-absorbing structure, which is made from a light-absorbing composition as claimed in claim 1, wherein the light-absorbing structure is a light-absorbing panel, a light-absorbing film or a light-absorbing fiber.

14. The light-absorbing structure as claimed in claim 13, wherein the light-absorbing structure has a visible light transmittance and a infrared absorbance, and a product of a sum of the visible light transmittance and the infrared absorbance multiplied by 100 is larger than or equal to 100.

15. The light-absorbing structure as claimed in claim 14, wherein the light-absorbing structure has a visible light transmittance and an infrared absorbance, and a product of a sum of the visible light transmittance and the infrared absorbance multiplied by 100 is larger than or equal to 124.
